(19) United States
(12) Patent Application Publication
(10) Pub. No.: US 2006/0007225 A1
(43) Pub. Date: Jan. 12, 2006

(54) Display apparatus and control method thereof

(76) Inventor: Young-chan Kim, Euiwang-si (KR)

Correspondence Address: STANZIONE & KIM, LLP, 919 18TH STREET, N.W., SUITE 440, WASHINGTON, DC, 20006, US

(21) Appl. No.: 11/144,734

(22) Filed: Jun. 6, 2005

(30) Foreign Application Priority Data
Jun. 28, 2004 (KR) 2004-49147

(51) Int. Cl. G09G 5/00

(52) U.S. Cl. 345/211

(57) ABSTRACT

A display apparatus including a main body, a power key provided in the main body to turn on/off power, a display to display an image thereon a signal input part to receive an image signal from an external device, a power supply to supply the power to circuits of the display apparatus, and a controller to detect the image signal input through the signal input part, to control the power supply and the display to convert the display apparatus into an automatic off mode in which the power supplied to the circuits is cut off when a normal image signal is not input, to maintain the automatic off mode if the image signal input is determined to be abnormal when the power key is input in the automatic off mode, and to display the image if the image signal input is determined to be normal. Thus the display apparatus and control method thereof prevents a user from being confused as to whether the power key is input to the display apparatus in a power off mode or in an automatic off mode, and is thereby simply operated by the user.

### CROSS-REFERENCE TO RELATED APPLICATIONS

This application claims the benefit of Korean Patent Application No. 200449147, filed Jun. 28, 2004, in the Korean Intellectual Property Office, the disclosure of which is incorporated herein in its entirety and by reference.

### BACKGROUND OF THE INVENTION

1. Field of the Invention

The present general inventive concept relates to a display apparatus comprising a main body, a power key provided in the main body to turn on/off power, and a display to display an image thereon, and more particularly, to a display apparatus and control method thereof to prevent a user from being confused as to whether the power key is input to the display apparatus in a power off mode or in an automatic off mode, and to thereby be simply operated by the user.

2. Description of the Related Art

Generally, a conventional display apparatus has a main body, a power key provided in the main body to turn on/off power, and a display displaying an image, and goes into a power-on state by supplying power to circuits in the display apparatus if the power key is input when the display apparatus is in a power off state. Accordingly, the display apparatus displays an image on a screen in the display by processing an image signal input from an external device. Further, the display apparatus turns off the power by cutting off the power supplied to the circuits in the display apparatus if the power key is input thereto when the display apparatus is in the power on state.

The display apparatus displays an abnormal warning message to inform that an abnormal image signal is input thereto, if an image signal input from the external device is abnormal when the display apparatus is in the power on state. After a predetermined amount of time passes, the display apparatus eliminates the abnormal warning message and is converted into an automatic off mode to reduce power consumption by cutting off the power supplied to the circuits therein. Thereafter, when a normal image signal is input in the automatic off mode, the display apparatus supplies the power to the circuits therein and displays the image according to the image signal on the screen of the display.

However, when a conventional display apparatus is converted into the automatic off mode according to the input of the abnormal image signal, a user has a problem of determining whether the display apparatus is in a power off mode or in the automatic off mode by viewing the screen.

Accordingly, when the display apparatus is operated in the automatic off mode, the user may input the power key to turn on the power through a misunderstanding that the display apparatus is in the power off mode so that the power of the display apparatus is turned off by the inputting of the power key unrelated to the automatic off mode. Then, the user has to input the power key again so as to turn on the power because the automatic off mode was converted into the power off mode.

Also, the conventional display apparatus still has a problem of determining whether the display apparatus is in the power off mode or in the automatic off mode, because if the abnormal image signal is input thereto when the display apparatus is in the power on state by pushing the power key again, the conventional display apparatus is converted into the automatic off mode again.

### SUMMARY OF THE INVENTION

Accordingly, the present general inventive concept provides a display apparatus and control method thereof that prevents a user from being confused as to whether the power key is input to the display apparatus in a power off mode or in an automatic off mode, and therefore is simple for the user to operate.

Additional aspects and advantages of the general inventive concept will be set forth in part in the description which follows and, in part, will be obvious from the description, or may be learned by practice of the general inventive concept.

The foregoing and/or other aspects and advantages of the present general inventive concept are achieved by providing a display apparatus comprising a main body, a power key provided in the main body to turn on/off power, a display to display an image, a signal input part to receive an image signal from an external device, a power supply to supply the power to circuits of the display apparatus, and a controller to detect the image signal input through the signal input part, to control the power supply and the display to convert the display apparatus into an automatic off mode in which the power supplied to the circuits of the display apparatus is cut off when a normal image signal is not input thereto, to maintain the automatic off mode if the image signal input thereto is determined to be abnormal when the power key is input in the automatic off mode, and to display the image if the image signal input thereto is determined to be normal.

The display apparatus may further comprise an OSD (On Screen Display) generator to generate an abnormal input signal OSD message, and the controller may be converted into the automatic off mode by controlling the OSD generator to display the abnormal input signal OSD message and controlling the power supply to cut off the supplying of the power when a predetermined amount of time passes after the abnormal input signal OSD message is displayed, when the normal image signal is not input through the signal input part.

The controller can control the power supply and the display to display the image according to the image signal when the normal image signal is input in the automatic off mode.

The controller can maintain the automatic off mode by controlling the OSD generator to display the abnormal input signal OSD message when the image signal input is determined to be abnormal, and controlling the power supply to cut off the supplying of the power to the circuits when the predetermined amount of time passes after the abnormal input signal OSD message is displayed, when the power key is input thereto in the automatic off mode.

The foregoing and/or other aspects and advantages of the present general inventive concept may also be achieved by providing a control method of a display apparatus comprising a main body, a power key provided in the main body to turn on/off power, and a display to display an image, the control method comprising detecting whether an image signal from an external device is normal, converting the display apparatus into an automatic off mode in which supplying of power to circuits of the display apparatus is cut off when a normal image signal is not input based on the detecting of whether the image signal is normal, detecting whether the power key is input after the converting of the display apparatus into the automatic off mode, maintaining the automatic off mode when the normal image signal is not input in a case in which the power key is input, and displaying the image according to the image signal on a screen in the display and supplying the power to the circuits when the normal image signal is input when the power key is inputted.

The control method may further comprise providing an OSD (On Screen Display) generator, and the converting of the display apparatus into the automatic off mode may comprise displaying an abnormal input signal OSD message by controlling the OSD generator when the normal image signal is not input, and cutting off the supplying of the power to the circuits when a predetermined time passes after the input signal abnormal OSD message is displayed thereon.

The control method may further comprise displaying the image according to the image signal on the screen of the display and supplying the power to the circuits when the normal signal is input in the automatic off mode.

### BRIEF DESCRIPTION OF THE DRAWINGS

These and other aspects and advantages of the present general inventive concept will become apparent and more readily appreciated from the following description of the embodiments, taken in conjunction with the accompany drawings of which:

FIG. 1 is a control block diagram of a display apparatus according to an embodiment of the present general inventive concept; and

FIG. 2 is a control flow chart of the display apparatus of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

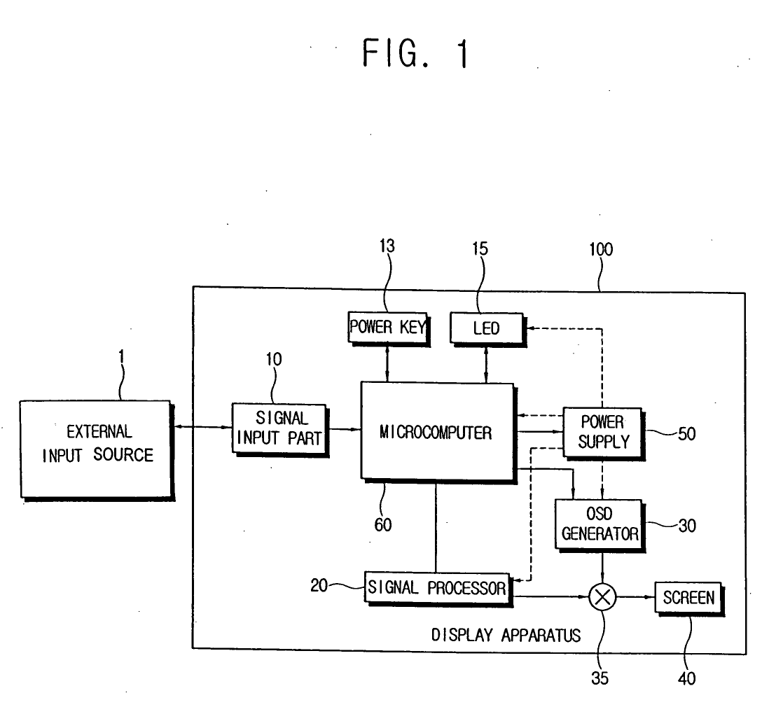

As shown in FIG. 1, a display apparatus 100 may comprise a signal input part 10 to receive an image signal from an external input source 1, a power supply 50 to supply power to circuits in the display apparatus 100, an OSD (On Screen Display) generator 30 to generate an abnormal input signal OSD message, and a display to display an image. The display may comprise a screen 40 to display the image thereon according to the image signal, a signal processor 20 to process the image signal input from the external input source 1 to be displayable on the screen 40, and a mixer 35 to mix the image signal output from the signal processor 20 and an OSD signal output from the OSD generator 30 to thereby output an image signal to the screen 40. Also, the display apparatus 100 may comprise a power key 13 to turn on/off the power, an LED (Light Emitting Diode) 15 to be turned on/off so as to inform a user whether the circuits therein are supplied with power; and a microcomputer 60 to act as a controller to detect the image signal input through the signal input part 10, to control the power supply 50 and the signal processor 20 to convert the mode of the display apparatus 100 into an automatic off mode in which the power supplied to the circuits by the power supply 50 is cut off when a normal image signal is not input to the display apparatus 100, and in a case that the power key 13 is input in the automatic off mode, to maintain the automatic off mode when the input image signal is determined to be abnormal and to display the image on the screen 40 when the input image signal is determined to be normal.

The power key 13 can be provided in a main body of the display apparatus 100, and may comprise a button part to output a signal to the microcomputer 60 by being selectively input by the user so as to turn on/off the power of the display apparatus 100.

The external input source 1 inputs the image signal to the display apparatus 100 through the signal input part 10 of the display apparatus 100, and may comprise a PC, a DVD player, or a set top box, etc.

The signal input part 10 is employed to receive the image signal from the external input source 1, and may receive the image signal and an H/V sync signal, etc., by being connected to the external input source 1 through an input cable so as to receive the image signal from the external input part 1.

The OSD generator 30 can generate the abnormal input signal OSD message to indicate that the image signal input to the display apparatus 100 is erred by control of the microcomputer 60.

The signal processor 20 outputs the image signal after processing the image signal received from the external input source 1 to be displayable on the screen 40. Herein, the signal processor 20 can correspondingly process the image signal according to a type of screen 40, such as an LCD, a CRT, etc.

When the power key 13 is input in the power off state, the microcomputer 60 controls the power supply 50 to turn on the LED 15, and to supply the power to the circuits of the display apparatus 100 to convert the mode of the display apparatus into the power on mode. Then, the microcomputer 60 controls the signal processor 20 to display the image on the screen 40 by processing the image signal input from the external input source 1. When the power key 13 is input in the power on state, the microcomputer 60 turns off the power by controlling the power supply 50 to turn off the LED 15 and cut off the power supplied to the circuits in the display apparatus 100.

The microcomputer 60 may store a predetermined frequency range of the H/V sync signal of the normal image signal from the external input source 1. Accordingly, the microcomputer 60 can compare a frequency of the H/V sync signal input through the signal input part 10 in the power on state with the predetermined frequency range of the H/V sync signal. When the normal image signal is not input thereto based on the comparison of the frequency, the microcomputer 60 can control the OSD generator 30 to display an abnormal input signal OSD message to indicate that the input signal is abnormal. Also, the microcomputer 60 can control the OSD generator 30 to eliminate the abnormal input signal OSD message when a predetermined amount of time passes after the OSD message is displayed. Then, the microcomputer 60 can control the power supply 50 to turn off the LED 15, and cut off the supplying of the power to the circuits in the display apparatus 100 to convert the mode of the display apparatus 100 into the automatic off mode.

When the power key 13 is input in the automatic off mode while the microcomputer 60 determines that the image signal input thereto is abnormal, the microcomputer 60 can control the OSD generator 30 to repeatedly display the abnormal input signal OSD message. Accordingly, when the predetermined amount of time passes after the abnormal input signal I OSD message is displayed, the microcomputer 60 can control the OSD generator 30 to eliminate the abnormal input signal OSD message and can control the power supply 50 to cut off the supplying of the power to the circuits of the display apparatus 100, to thereby maintain the automatic off mode.

When the power key 13 is input in the automatic off mode while the microcomputer 60 determines that the image signal input thereto is normal, the microcomputer 60 can control the power supply 50 to turn on the LED 15 and to supply the power to the circuits of the display apparatus 100. Also, the microcomputer 60 can control the signal processor 20 to display a normal image according to the image signal on the screen 40.

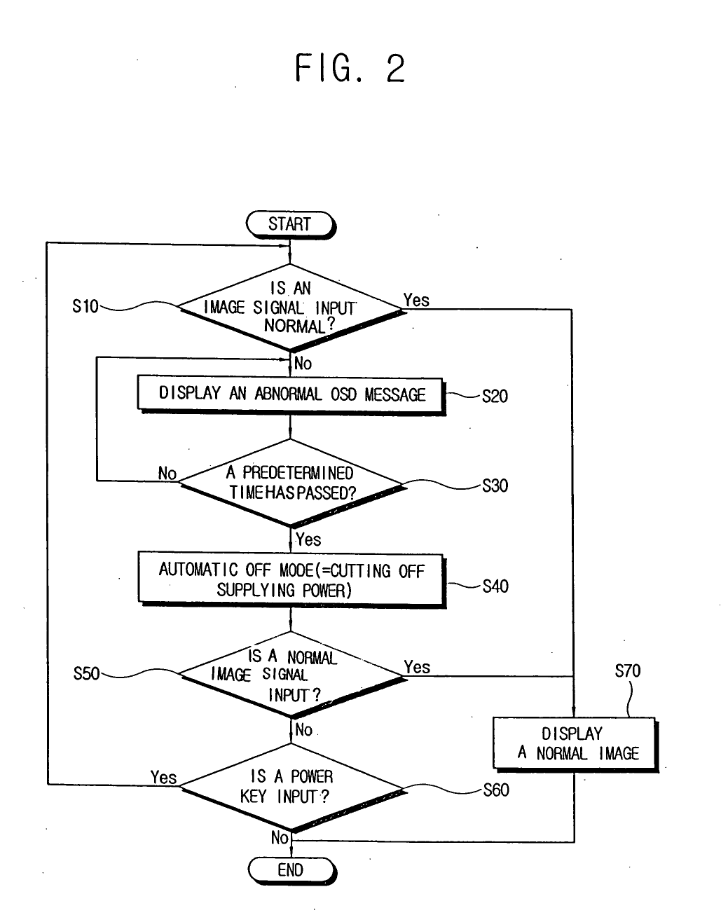

A control method of the display apparatus of FIG. 1, according to an embodiment of the present general inventive concept is described while referring to FIG. 2 as follows. First, the microcomputer 60 can determine whether the image signal input through the signal input part 10 is normal in the power on state at operation S10. If the microcomputer 60 determines that the image signal input thereto is abnormal, the microcomputer 60 can control the OSD generator 30 to display the abnormal input signal OSD message on the screen 40 at operation S20. After the abnormal input signal OSD message is displayed, the microcomputer 60 can determine whether a predetermined amount of time has passed at operation S30. After the predetermined amount of time passes, the microcomputer 60 can control the OSD generator to eliminate the abnormal input signal OSD message and can convert the display apparatus 100 into the automatic off mode by controlling the power supply 50 to turn off the LED 15 and cut off the supplying of the power to the circuits in the display apparatus 100 at operation S40. The microcomputer 60 can continuously detect whether the normal image signal is input thereto at operation S50. Also, the microcomputer 60 can detect whether the power key 13 is input in the automatic off mode at operation S60. If the microcomputer 60 detects that the power key 13 is input while the microcomputer 60 determines that the image signal input is abnormal, the microcomputer 60 can repeatedly operate from the operation S10 to the operation S40 in which the display apparatus 100 maintains the automatic off mode. If the microcomputer 60 determines that the normal image signal is input thereto based on the determination of the operation S10, the microcomputer 60 can control the signal processor 20 and the power supply 50 to display the normal image according to the image signal on the screen 40 at operation S70. If the microcomputer 60 determines that the normal image signal is input thereto based on the determination of the operation S50, the microcomputer 60 can control the signal processor 20 and the power supply 50 to display the normal image according to the image signal on the screen 40 at operation 70.

Through this operation, the display apparatus 100 according to the present invention is converted into the automatic off mode according to the inputting of the abnormal image signal so that the user may simply determine whether the display apparatus is in the power off mode or the automatic off mode by viewing the screen 40. In other words, when the user inputs the power key 13 to turn on the power through a misunderstanding that the display apparatus 100 is in the power off mode when in fact the display apparatus is in the automatic off mode, the display apparatus 100 can display the abnormal input signal OSD message according to inputting of the abnormal image signal on the screen 40 and maintain the automatic off mode. When the display apparatus 100 is in the power off mode, the display apparatus 100 can turn on the power by the inputting of the power key.

Accordingly, when the user inputs the power key 13 in the automatic off mode through a misunderstanding that the display apparatus 100 is in the power off mode, the abnormal input signal OSD message can be displayed on the screen 40, so that the user may see that the display apparatus is in the automatic off mode. Also, the power supplied to the display apparatus 100 is not turned off by the inputting of the power key 13, and the display apparatus 100 maintains the automatic off mode. Accordingly, the display apparatus 100 eliminates problems in which the user has to input the power key again so as to turn on the power, so that the power supplied to the display apparatus 100 is not turned off by the inputting of the power key 13 and the display apparatus 100 maintains the automatic off mode.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus comprising:
a main body;
a power key provided in the main body to turn on/off power;
a display to display an image;
a signal input part to receive an image signal from an external device;
a power supply to supply the power to circuits of the display apparatus; and
a controller to detect the image signal input through the signal input part, to control the power supply and the display to convert the display apparatus into an automatic off mode in which the power supplied to the circuits of the display apparatus is cut off when a normal image signal is not input thereto, to maintain the automatic off mode if the image signal input thereto is determined to be abnormal when the power key is input in the automatic off mode, and to display the image when the image signal input thereto is determined to be normal.

2. The display apparatus according to claim 1, further comprising an OSD (On Screen Display) generator to generate an abnormal input signal OSD message, and
the controller converts the display apparatus into the automatic off mode by controlling the OSD generator to display the abnormal input signal OSD message and controlling the power supply to cut off the power supplied to the circuits of the display apparatus when a predetermined amount of time passes after the abnormal input signal OSD message is displayed, when the normal image signal is not input through the signal input part.

3. The display apparatus according to claim 2, wherein the controller controls the power supply and the display to display the image according to the image signal when the normal image signal is input in the automatic off mode.

4. The display apparatus according to claim 2, wherein the controller maintains the automatic off mode by controlling the OSD generator to display the abnormal input signal OSD message when the image signal input thereto is determined to be abnormal and controlling the power supply to cut off the power supplied to the circuits of the display apparatus when the predetermined amount of time passes-after the abnormal input signal OSD message is displayed, when the power key is input in the automatic off mode.

5. The display apparatus according to claim 1, further comprising an LED (light emitting diode) to turn on/off according to whether the circuits of the display apparatus are supplied with the power.

6. The display apparatus according to claim 5, wherein when the controller converts the display apparatus mode into the automatic off mode, the controller turns off the LED.

7. The display apparatus according to claim 5, wherein when the controller displays the image when the normal image signal is input, the controller turns on the LED.

8. The display apparatus according to claim 1, wherein the controller stores a predetermined frequency range corresponding to the normal image signal, and compares a frequency of the image signal received by signal input part to the predetermined frequency range to determine whether the image signal is normal.

9. The display apparatus according to claim 8, wherein the image signal is an H/V sync signal.

10. A control method of a display apparatus comprising a main body, a power key provided in the main body to turn on/off power, a display to display an image thereon, the control method comprising:
detecting whether an image signal from an external device is normal;
converting the display apparatus into an automatic off mode in which supplying of power to circuits of the display apparatus is cut off when a normal image signal is not input based on the detecting of whether the image signal is normal;
detecting whether the power key is input after the converting of the display apparatus into the automatic off mode;
maintaining the automatic off mode when the normal image signal is not input in the case that the power key is input; and
displaying the image according to the image signal on a screen in the display and supplying the power to the circuits when the normal image signal is input when the power key is input.

11. The control method of the display apparatus according to claim 10, further comprising providing an OSD generator, and
the operation of converting of the display apparatus into the automatic off mode comprises displaying an abnormal input signal OSD message by controlling the OSD generator when the normal image signal is not input, and cutting off the power supplied to the circuits when a predetermined time passes after the abnormal input signal OSD message is displayed.

12. The control method of the display apparatus according to claim 11, further comprising:
displaying the image according to the image signal on the screen of the display; and
supplying the power to the circuits when the normal signal is input in the automatic off mode.

13. The control method according to the display apparatus according to claim 10, wherein the detecting of whether the image signal is normal comprises comparing a frequency of the image signal to a predetermined frequency range.

14. A display apparatus to display an input image signal, comprising:
a power key to turn on/off the display apparatus; and
a controller to convert the display apparatus to an automatic off state upon detection of a predetermined condition, the controller preventing the power key from turning off the display apparatus when the display apparatus is in the automatic off state.

15. The display apparatus according to claim 14, wherein the predetermined condition is a condition where a normal image signal is not input to the display apparatus.

16. The display apparatus according to claim 14, further comprising an OSD (on screen display) generator to generate an OSD message to alert a user of the predetermined condition.

17. The display apparatus according to claim 16, wherein the controller converts the display apparatus when a predetermined amount of time passes-after the OSD message is generated.

18. The display apparatus according to claim 16, wherein the controller controls the display apparatus to display an image when a normal input image signal is input in the automatic off state.

19. A control method of a display apparatus comprising:
determining whether an input signal is normal;
converting the display apparatus into an automatic off mode when a predetermined amount of time passes after it is determined that the input signal is abnormal;
informing the user of the abnormal signal when the display apparatus is in the automatic off mode and a power key is pressed; and
removing the display apparatus from the automatic off mode and displaying an image corresponding to the input signal when the input signal is normal.

20. The control method according to claim 19, wherein the informing of the user of the abnormal signal comprises generating and displaying an OSD (on screen display) message to inform the user of the abnormal signal.
